(19) United States
(12) Patent Application Publication
(10) Pub. No.: US 2026/0101271 A1
(43) Pub. Date: Apr. 9, 2026

(54) METHOD AND APPARATUS FOR PERFORMING AN ON-DEMAND SIB1 REQUEST PROCEDURE

(71) Applicant: WNC Corporation, Hsinchu (TW)

(72) Inventor: Hung-Chen CHEN, Hsinchu (TW)

(21) Appl. No.: 19/348,528

(22) Filed: Oct. 2, 2025

Related U.S. Application Data
(60) Provisional application No. 63/703,242, filed on Oct. 4, 2024.

(51) Int. Cl. H04W 48/14; H04W 48/20

(52) U.S. Cl. CPC H04W 48/14; H04W 48/20

(57) ABSTRACT

A method for performing an on-demand SIB1 request procedure is provided. The method is implemented by a user equipment (UE) and includes triggering, by an upper layer of the UE, a lower layer of the UE to initiate a random access (RA) procedure for an on-demand system information block type 1 (SIB1) request to a cell. The method includes considering, by the upper layer of the UE, the cell as barred in a case that an RA problem for the on-demand SIB1 request is received from the lower layer of the UE, wherein the RA problem indicates that a maximum number of preamble transmission attempts is reached. The method includes acquiring, by the upper layer of the UE, an on-demand SIB1 in a case that an acknowledgment for the on-demand SIB1 request is received from the lower layer of the UE.

### CROSS REFERENCE TO RELATED APPLICATIONS

This application claims the benefit of U.S. Provisional Application No. 63/703,242, entitled “Method and Apparatus of Supporting On-Demand SIB1 Request for Network Energy Saving”, filed on Oct. 4, 2024, the entirety of which is incorporated by reference herein.

### TECHNICAL FIELD

The present disclosure generally relates to wireless communication. More specifically, aspects of the present disclosure relate to a method and an apparatus for performing an on-demand SIB1 request procedure.

### BACKGROUND

Unless otherwise indicated herein, the approaches described in this section are not prior art to the claims listed below and are not admitted as prior art by inclusion in this section.

Network energy saving in 5G has received significant attention in recent years because of the increasing number of small cells and the use of massive multiple-input multiple-output (MIMO) antennas. It is undoubtedly important to reduce the environmental impact and to help operators save on their operating expenses. Therefore, there is a need to develop specified approaches for network energy saving in 5G. 3GPP Release 18 addressed the issue of network energy saving by introducing techniques for SSB (Synchronization Signal Block)-less SCell (Secondary Cell) operations for inter-based CA (Carrier Aggregation) for FR1 and co-located cells. That is, for an intra-band or inter-band CA SCell, a UE may obtain a timing reference and AGC (Automatic Gain Control) source from another serving cell in case the UE is provided with neither SSB nor SMTC (SSB-based Measurement Timing Configuration) configuration for this SCell, as described in TS 38.300 and TS 38.331 of Release 18. In addition, the cell DTX/DRX (Discontinuous Transmission or Discontinuous Reception) mechanism has been specified to facilitate reducing the gNB downlink transmission or uplink reception active time. Specifically, when cell DTX is configured and activated for a particular cell, the UE may not monitor PDCCH (Physical Downlink Control Channel) in selected cases or may not monitor SPS (Semi-Persistent Scheduling) occasions during cell DTX non-active duration of the particular cell. When cell DRX is configured and activated for a particular cell, the UE does not transmit CG (Configured Grant) resources or does not transmit an SR (Scheduling Request) during the cell DRX non-active duration of the concerned cell. This feature only applies to UEs in RRC_CONNECTED state and does not impact the Random Access procedure, SSB transmission, paging, and broadcasting system information. Other solutions were included in 3GPP Release 18 to further save NW (Network) power. One solution is that an NG-RAN (Next Generation Radio Access Network) node owning a coverage cell can request neighboring NG-RAN nodes owning a capacity booster cell to switch on some SSB beams within the cell, which are deactivated. Another solution is that an NG-RAN node can page certain UEs (e.g., stationary UEs) in the RRC_INACTIVE state on a limited set of beams, instead of paging on all the beams within the cell. To avoid negative impacts on UEs that do not support the feature(s) related to network energy saving, if a cell is activating or going to activate NES cell DTX/DRX, the cell can allow the access of UEs capable of NES cell DTX/DRX via a single bit in SIB1 but prevent the access of UEs not capable of cell DTX/DRX using barring mechanisms as introduced in TS 38.300 of Release 18.

Due to the time limit, certain beneficial techniques for network energy saving have not yet been considered in 3GPP Release 18. There is an urgent need to introduce these beneficial techniques to fully complete the goals of network energy saving.

One of the beneficial techniques is to support on-demand SIB1 (System Information Block 1) for UEs (User Equipment) in RRC_IDLE state or RRC_INACTIVE state, as stated in RP-242354. It is noted that SIB1 carries the most critical information required for the UE to access the cell, e.g., random access parameters. SIB1 also includes information regarding the availability and scheduling of other SIBs. For a cell that supports NES mode, the cell may not always transmit its SIB1, but only transmit its SIB1 when an IDLE/INACTIVE UE (i.e., a UE in the RRC_IDLE state or in the RRC_INACTIVE state) attempts to camp on the cell. Since on-demand SIB1 is not always transmitted (or broadcast) by the cell, the power consumption of a base station of this cell can be reduced, especially when no UE is currently camping on the cell. However, the details procedures and signaling methods to support on-demand SIB1 requests are still under discussion. Therefore, there is a need to provide proper schemes to address this issue.

### SUMMARY

The following summary is illustrative only and is not intended to be limiting in any way. That is, the following summary is provided to introduce concepts, highlights, benefits, and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, a method and an apparatus for performing an on-demand SIB1 request procedure are provided in the present disclosure. The main purpose of the disclosure is to support on-demand SIB1 request for network energy saving, including designs related to information provided in a UL (Uplink) WUS (Wake-Up Signal) configuration for a UE to perform an on-demand SIB1 request procedure on a cell which does not broadcast SIB1 but support on-demand SIB1 request from a UE, triggering condition(s) of performing an on-demand SIB1 request procedure, signaling for indicating the update of a UL WUS configuration and an on-demand SIB1, failure handling mechanisms for an on-demand SIB1 request procedure, NES cell barring mechanism, UE capabilities of supporting an on-demand SIB1 request procedure, and maintenance of stored UL WUS configuration(s).

In an exemplary embodiment, a method for performing an on-demand SIB1 request procedure is provided. The method is implemented by a user equipment (UE) and comprises triggering, by an upper layer of the UE, a lower layer of the UE to initiate a random access (RA) procedure for an on-demand system information block type 1 (SIB1) request to a cell. The method includes considering, by the upper layer of the UE, the cell as barred in a case that an RA problem for the on-demand SIB1 request is received from the lower layer of the UE, wherein the RA problem indicates that a maximum number of preamble transmission attempts is reached. The method includes acquiring, by the upper layer of the UE, an on-demand SIB1 in a case that an acknowledgment for the on-demand SIB1 request is received from the lower layer of the UE.

In an exemplary embodiment, an apparatus for performing an on-demand SIB1 request procedure is provided. The apparatus comprises a transceiver and a processor. The transceiver, which, during operation, wirelessly communicates with at least one network node. The processor is communicatively coupled to the transceiver such that, during operation, the processor performs operations comprising triggering, by an upper layer of the apparatus, a lower layer of the apparatus to initiate a random access (RA) procedure for an on-demand system information block type 1 (SIB1) request to a cell. The processor performs operations comprising considering, by the upper layer of the apparatus, the cell as barred in a case that an RA problem for the on-demand SIB1 request is received from the lower layer of the apparatus, wherein the RA problem indicates that a maximum number of preamble transmission attempts is reached. The processor performs operations comprising acquiring, by the upper layer of the apparatus, an on-demand SIB1 in a case that an acknowledgment for the on-demand SIB1 request is received from the lower layer of the apparatus.

In an exemplary embodiment, a method for performing an on-demand SIB1 request procedure is provided. The method is implemented by a serving cell and comprises transmitting an on-demand system information block type 1 (SIB1) configuration of a target cell to a user equipment (UE), wherein the valid on-demand SIB1 configuration of the target cell at least comprises information of a starting time and a time duration of type 0 physical downlink control channel (PDCCH) monitoring occasions for an on-demand SIB1, wherein the starting time is associated with a reference time point, and the reference time point is determined based on a timing of receiving a corresponding random access (RA) response in response to a transmitting preamble for the on-demand SIB1 request.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale, as some components may be shown out of proportion to their size in actual implementation in order to clearly illustrate the concept of the present disclosure.

FIG. 1 shows a signaling procedure of performing an on-demand SIB1 request for network energy saving according to an implementation of the present disclosure.

FIG. 2 shows a new design for short messages according to an implementation of the present disclosure.

FIG. 3 shows a UE capability reporting procedure according to an implementation of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network functions or algorithms described in the present disclosure may be implemented by hardware, software or a combination of software and hardware. Described functions may correspond to modules which may be software, hardware, firmware, or any combination thereof. The software implementation may comprise computer executable instructions stored on computer-readable medium, such as memory or other type of storage devices. For example, one or more microprocessors or general-purpose computers with communication processing capability may be programmed with corresponding executable instructions and carry out the described network functions or algorithms. The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, a 5G New Radio (NR) Radio Access Network (RAN) or a 6G NR RAN) typically includes at least one Base Station (BS), at least one User Equipment (UE), and one or more optional network elements that provide connection towards a network. The UE communicates with the network (e.g., a Core Network (CN), an Evolved Packet Core (EPC) network, an Evolved Universal Terrestrial Radio Access Network (E-UTRAN), a 5G Core (5GC), or an internet), through an RAN established by one or more BSs.

It should be noted that, in the present disclosure, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GRPS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), 6G and/or LTE-A Pro. However, the scope of the present disclosure should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a ng-eNB as in an Evolved Universal Terrestrial Radio Access (E-UTRA) BS in connection with the 5GC, a next-generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access network. The BS supports the operations of the cells. Each cell is operable to provide services to at least one UE within its radio coverage. More specifically, each cell (often referred to as a serving cell) provides service to one or more UEs within its radio coverage (e.g., each cell schedules the downlink and optionally uplink resources to at least one UE within its radio coverage for downlink and optionally uplink packet transmissions). The BS can communicate with one or more UEs in the radio communication system through the plurality of cells. A cell may allocate Sidelink (SL) resources for supporting Proximity Service (ProSe) or Vehicle to Everything (V2X) service. Each cell may have overlapping coverage areas with other cells.

As discussed above, the frame structure for NR is to support flexible configurations for accommodating various next-generation (e.g., 5G or 6G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3rd Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a Downlink (DL) transmission data, a guard period, and an Uplink (UL) transmission data should at least be included, where the respective portions of the DL transmission data, the guard period, the UL transmission data should also be configurable, for example, based on the network dynamics of NR. In addition, SL resources may also be provided in an NR frame to support ProSe services or V2X services.

In addition, the terms “system” and “network” herein may be used interchangeably. The term “and/or” herein is only an association relationship for describing associated objects and represents that three relationships may exist. For example, A and/or B may indicate that: A exists alone, A and B exist at the same time, or B exists alone. In addition, the character “/” herein generally represents that the former and latter associated objects are in an “or”relationship.

It should be understood that the terms “on-demand SIB1 configuration” and “UL WUS configuration” may be used interchangeably throughout this disclosure with the term “SIB1 request configuration”.

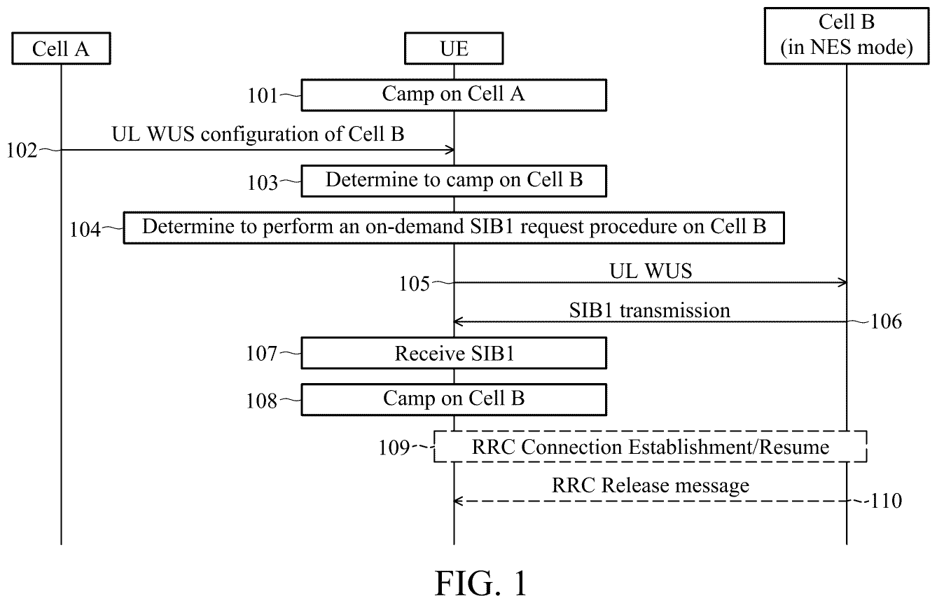

FIG. 1 shows a signaling procedure of performing an on-demand SIB1 request for network energy saving according to an implementation of the present disclosure. It is noted that one or more steps in FIG. 1 may or may not be performed. For example, an RRC connection establishment/resume procedure in step 109 may not be required when the UE does not have any DL (Downlink) data to receive or UL data to transmit, or the UE does not receive any paging message to indicate the UE to connect to the network (e.g., to answer a phone call). Similarly, a cell B (or its associated base station) may not transmit an RRC Release message (e.g., an RRC Release message as introduced in TS 38.331 of Release 18) to the UE when the UE does not connect to the cell B. On the contrary, when the UE is in the RRC_CONNECTED state, the NW may transmit an RRC Release message without a suspend configuration to instruct the UE to transit from the RRC_CONNECTED state to the RRC_IDLE state. The NW may transmit an RRC Release message with a suspend configuration (e.g., a suspend configuration as introduced in TS 38.331 of Release 18) to instruct the UE to transit from the RRC_CONNECTED state to the RRC_INACTIVE state.

Step 101: In some implementations, a UE (e.g., a UE in the RRC_IDLE state or in the RRC_INACTIVE state) may first camp on a cell A based on the results of performing a cell selection procedure or a cell re-selection procedure (e.g., as introduced in TS 38.304 of Release 18). The cell A may be the cell with the highest rank based on the cell selection criteria or the cell re-selection criteria, and/or based on frequency priority provided via a dedicated RRC signal or broadcasting system information.

In some implementations, the cell B may be an advanced NES cell (or Rel-19 NES cell) that supports at least a feature of on-demand SIB1 request. The cell B may determine its current mode, e.g., a regular mode or an NES mode. When the cell B is in a regular mode, the cell B may periodically broadcast its SIB1 (e.g., following the broadcast principles as defined in TS 38.331 of Release 18). When the cell B is in a NES mode and/or allows a UE to camp on, the cell B may provide a corresponding UL WUS configuration, which may include at least a dedicated RACH (Random Access Channel) related configuration to (neighboring) the cell A. It is noted that the cell A may be a regular cell or another advanced NES cell. A regular cell means that the cell works normally and does not support any NES-related feature(s). NES-related feature(s) may include Rel-18 NES feature(s) to support DTX/DRX and/or Rel-19 NES feature(s) to support on-demand SIB1 request, but not limited to. In addition, when the corresponding UL WUS configuration has been updated, the cell B may provide the updated UL WUS configuration to the cell A accordingly. On the contrary, when the cell B is in a regular mode and/or does not allow the UE to camp on, the cell B may not provide a corresponding UL WUS configuration, which may include at least a dedicated RACH (Random Access Channel) related configuration, to the (neighboring) cell A. In case the cell B has provided its UL WUS configuration to the cell A before, and the cell B switches to a regular mode (or does not allow a UE to camp on anymore), the cell B may inform the cell A to release the previously received UL WUS configuration. Consequently, the cell A may inform the UE that camps on the cell A to update the corresponding information (e.g., to release the corresponding UL WUS configuration of the cell B).

Step 102: In some implementations, the cell A may transmit (e.g., via a dedicated signal) or broadcast (e.g., via broadcasting system information) a UL WUS configuration of an advanced NES cell (e.g., the cell B, which is in NES mode) for an IDLE/INACTIVE UE that camps on the cell A. The Cell A may provide one or more UL WUS configuration of one or more advanced (neighboring) NES cell to the UE that currently camps on the cell A.

In some implementations, each UL WUS configuration may be associated with a WUS ID (Identify). In some implementations, the UE may receive WUS-related information (e.g., via SIB1, SIB3/4, or a newly designed SIB) from the cell A. In the WUS-related information, there may be a first list including one or more entries to indicate one PCI (Physical Cell Identity) or an associated cell ID of an advanced NES cell. In addition, there may be a second list which includes one or more entries to indicate a WUS ID. The first list and the second list may have the same number of entries, and the entries are listed in the same order. For example, the first list may be {PCI #1, PCI #2, PCI #3}, and the second list may be {WUS #1, WUS #2, WUS #2}. It means that when a UE attempts to camp on an advanced NES cell with PCI #1, the UE may use the UL WUS configuration indexed by WUS #1 to perform an on-demand SIB1 request procedure to the advanced NES cell with PCI #1. When the UE attempts to camp on an advanced NES cell with PCI #2, the UE may use the UL WUS configuration indexed by WUS #2 to perform an on-demand SIB1 request procedure to the advanced NES cell with PCI #2. When the UE attempts to camp on an advanced NES cell with PCI #3, the UE may also use the UL WUS configuration indexed by WUS #2 to perform an on-demand SIB1 request procedure to the advanced NES cell with PCI #3. It is noted that one or more advanced NES cells may share the same UL WUS configuration (e.g., the advanced NES cells are deployed on the same frequency, the advanced NES cells are in the same RAN notification area, or the advanced NES cells are in the same system information area). Sharing the same UL WUS configuration may be beneficial for reducing signaling overhead when broadcasting the WUS-related information. In some implementations, in the WUS-related information, there may be a third list including one or more entries to indicate frequencies where advanced NES cell(s) are deployed. One or more advanced NES cells may be associated with one entry of the third list (or a frequency). In addition, there may be a second list which includes one or more entries to indicate a WUS ID, and each WUS ID is associated with a UL WUS configuration.

In some implementations, a UL WUS configuration of an advanced NES cell may include at least a RACH-related configuration. The RACH-related configuration may include dedicated RA parameters or dedicated RA resources/RA occasions for a UE to transmit a preamble for an on-demand SIB1 request for a target advanced NES cell. In some implementations, when dedicated RA resources/RA occasions are not provided in a UL WUS configuration, a UE may use shared RA occasion(s) to transmit a preamble with a dedicated preamble index for an on-demand SIB1 request to a target advanced NES cell. It is noted that shared RA parameters or shared RA resources/RA occasions for a UE to transmit a preamble for an on-demand SIB1 request may be provided as part of WUS-related information. When dedicated RA resources/RA occasions are not provided in a UL WUS configuration for an advanced NES cell, shared RA resources/RA occasions may be used. In this case, the UL WUS configuration may provide one or more dedicated preamble indices. It is noted that shared RA resources/RA occasions are the RA resources/RA occasions that can be used for other usages (e.g., initial access from RRC_IDLE, performing RRC Connection Re-establishment procedure, RRC Connection Resume procedure from RRC_INACTIVE, Request for other SI) in case that an RA procedure is initiated. In some implementations, an advanced NES cell may be configured with SUL (Supplementary Uplink). When a UL WUS configuration of a target advanced NES cell (e.g., the cell B) includes RACH-related configuration (or on-demand SIB1 request configuration) on SUL and the criteria to select the SUL is fulfilled, the upper layer of the UE (e.g., the RRC layer) may trigger the lower layer of the UE (e.g., the MAC layer) to initiate a RA procedure on the SUL for an on-demand SIB1 request, using the PRACH preamble(s) and/or PRACH resource(s) indicated in the RACH related configuration (or on-demand SIB1 request configuration) on SUL. When a UL WUS configuration of a target advanced NES cell (e.g., the cell B) includes a RACH-related configuration (or on-demand SIB1 request configuration) on an NUL (normal UL) and the criteria to select the NUL is fulfilled, the upper layer of the UE (e.g., the RRC layer) may trigger the lower layer of the UE (e.g., the MAC layer) to initiate a RA procedure on the NUL for an on-demand SIB1 request, using the PRACH preamble(s) and/or PRACH resource(s) indicated in the RACH-related configuration (or on-demand SIB1 request configuration) on the NUL. Note that there may be an RSRP threshold for the selection between the NUL carrier and the SUL carrier. When the RSRP of the downlink pathloss reference is less than the RSRP threshold, the UE may select the SUL carrier to perform an RA procedure. Otherwise, the UE may select the NUL carrier to perform an RA procedure. In case the SUL is not configured or the RSRP threshold is not provided, the UE may select the NUL to perform an RA procedure when the RA procedure is initiated (e.g., for an on-demand SIB1 request).

In some implementations, a UL WUS configuration of an advanced NES cell may include type 0 PDCCH (Physical Downlink Control Channel) and/or associated search space ZERO (e.g., as introduced in TS 38.300 and TS 38.213 of Release-18) for receiving an on-demand SIB1 of the advanced NES cell. In some implementations, when type 0 PDCCH (Physical Downlink Control Channel) and/or associated search space ZERO is not present in a UL WUS configuration of an advanced NES cell, a UE may expect that type 0 PDCCH and/or associated search space ZERO for receiving an on-demand SIB1 of the advanced NES cell may be provided in MIB (Master Information Block) broadcast by the target advanced NES cell. In some implementations, when type 0 PDCCH and/or associated search space ZERO is not present in a UL WUS configuration of an advanced NES cell, the UE may expect that type 0 PDCCH and/or associated search space ZERO for receiving an on-demand SIB1 of the advanced NES cell may be provided in a RAR (Random Access Response) in response to a preamble transmitting by the UE for an on-demand SIB1 request, wherein the RAR is transmitted by the target advanced NES cell. For example, when an advanced NES cell considers that its type 0 PDCCH and/or associated search space ZERO for receiving an on-demand SIB1 does not change frequently, the advanced NES cell may provide its type 0 PDCCH and/or associated search space ZERO in a corresponding UL WUS configuration. On the contrary, the advanced NES cell may provide its type 0 PDCCH and/or associated search space ZERO in its MIB or a RAR (in response to a preamble for an on-demand SIB1 request). In one example, a UE may receive type 0 PDCCH for receiving an on-demand SIB1 in a UL WUS configuration and may receive associated search space ZERO for receiving an on-demand SIB1 in a RAR. In another example, a UE may receive type 0 PDCCH for receiving an on-demand SIB1 in a RAR and may receive associated search space ZERO for receiving an on-demand SIB1 in an MIB. In some implementations, a UE may store type 0 PDCCH and associated search space ZERO for receiving an on-demand SIB1 of the advanced NES cell from a corresponding UL WUS configuration, a received RAR, or an MIB (e.g., an MIB of cell B), and may use the stored type 0 PDCCH and associated search space ZERO for receiving on-demand SIB1 once the on-demand SIB1 is considered to be broadcast by the advanced NES cell. It is noted that type 0 PDCCH for receiving an on-demand SIB1, type 0 PDCCH monitoring occasions for on-demand SIB1, and on-demand SIB1 PDCCH may be exchangeable in this invention. It is also noted that the search space ZERO for receiving on-demand SIB1 and the on-demand SIB1 search space may be exchangeable in this disclosure.

In some implementations, a UL WUS configuration of an advanced NES cell may include a starting time and/or a time duration of type 0 PDCCH for receiving an on-demand SIB1 of the advanced NES cell. In some implementations, when a starting time and/or a time duration of type 0 PDCCH is not present in a UL WUS configuration of an advanced NES cell, a UE may expect that the starting time and/or the time duration of type 0 PDCCH for receiving on-demand SIB1 of the advanced NES cell may be provided in a RAR (Random Access Response) in response to a preamble transmitting by the UE for an on-demand SIB1 request, wherein the RAR is transmitted by the target advanced NES cell. In some implementations, a UE may store a starting time and/or a time duration of type 0 PDCCH for receiving on-demand SIB1 of the advanced NES cell from a corresponding (valid) UL WUS configuration, a received RAR, or an MIB (e.g., an MIB of the cell B) and may use the stored starting time and/or the time duration of type 0 PDCCH for receiving an on-demand SIB1 once the on-demand SIB1 is considered to be broadcast by the advanced NES cell. For example, the on-demand SIB1 is considered to be broadcast by the advanced NES cell when the UE transmits a preamble for an on-demand SIB1 request to the advanced NES cell and receives a RA response of the preamble from the advanced NES cell. In some implementations, when a UE does not receive any information on the starting time of type 0 PDCCH for receiving an on-demand SIB1 of an advanced NES cell, the UE may start receiving an on-demand SIB1 of the advanced NES cell after receiving an RAR in response to an on-demand SIB1 request or may start receiving an on-demand SIB1 based on its implementation or a pre-defined starting time. In some implementations, when a UE does not receive any information of a time duration of type 0 PDCCH for receiving an on-demand SIB1 of an advanced NES cell, the UE may stop receiving an on-demand SIB1 of the advanced NES cell based on its implementations or a pre-defined time period TP1. It is noted that the starting time/duration may be in unit(s) of slot(s), subframe(s), frame(s), ms(s), second(s). In some implementations, a starting time and/or a time duration of type 0 PDCCH for receiving an on-demand SIB1 of the advanced NES cell may be pre-defined or pre-configured. In some implementations, a reference time point associated with a starting time for receiving an on-demand SIB1 of the advanced NES cell may be the timing of transmitting a preamble for an on-demand SIB1 request or the timing of receiving a corresponding RAR in response to a preamble being transmitted for an on-demand SIB1 request. In some implementations, a reference time point associated with a starting time for receiving an on-demand SIB1 of the advanced NES cell may be configured (e.g., in a corresponding UL WUS configuration). For example, the network may instruct that the reference time point is the timing of transmitting a preamble for an on-demand SIB1 request. In another example, the network may instruct that the reference time point is the timing of receiving a corresponding RAR in response to a transmitting preamble for an on-demand SIB1 request. In some implementations, a time offset may be configured (e.g., in a corresponding UL WUS configuration) to indicate a temporal offset relative to the reference time point. The time offset may indicate a time gap between a reference time point and its corresponding starting time. The UE may start receiving an on-demand SIB1 at the corresponding starting time. The time offset may be used to determine when the time duration of type 0 PDCCH for receiving an on-demand SIB1 of the advanced NES cell begins.

In some implementations, a UL WUS configuration of an advanced NES cell may include information of the on-demand SIB1 periodicity. For example, the UL WUS configuration may indicate that the on-demand SIB1 will be broadcast by following the regular way (e.g., with the periodicity of 160 ms). On the contrary, the UL WUS configuration may indicate that the on-demand SIB1 will be broadcast by following a specific way (e.g., with the periodicity shorter than 160 ms). In some implementations, the value of the shorter periodicity for SIB1 broadcasting may be provided in a UL WUS configuration, a received RAR, or an MIB (e.g., an MIB of the cell B). The value of the shorter periodicity for SIB1 broadcasting may be pre-defined or configured by the NW. In some implementations, a UE may store SIB1 periodicity for receiving on-demand SIB1 of the advanced NES cell from a corresponding UL WUS configuration, a received RAR, or an MIB (e.g., an MIB of the cell B) and may use the stored SIB1 periodicity for receiving an on-demand SIB1 once the on-demand SIB1 is considered to broadcast by the advanced NES cell or the UE initiate a SIB1/SI acquisition procedure.

In some implementations, a UL WUS configuration of an advanced NES cell may include a value of the power ramping step and/or the maximum number of preamble transmissions for an on-demand SIB1 request. A UE may apply the value of the power ramping step and/or the maximum number of preamble transmissions when initiating an RA procedure for an on-demand SIB1 request. When the value of the power ramping step and/or the maximum number of preamble transmissions is not present in the UL WUS configuration, the UE may apply a value of power ramping step and/or the maximum number of preamble transmissions configured/provided by the previous/current camped cell (e.g., the cell A). In some implementations, a UE may store a value of power ramping step and/or the maximum number of preamble transmissions for an on-demand SIB1 request to the advanced NES cell from a corresponding UL WUS configuration, a received RAR, or an MIB (e.g., an MIB of the cell B) and may use the stored value of power ramping step and/or the maximum number of preamble transmission once the UE determines to initiate an RA procedure for an on-demand SIB1 request to the advanced NES cell.

In some implementations, a UL WUS configuration of an advanced NES cell may include a life timer. When a UE receives the UL WUS configuration, the corresponding life timer starts. The stored UL WUS configuration may be considered valid when the life timer is running. The stored UL WUS configuration may be considered invalid when the life timer expires. In some implementations, a UL WUS configuration of an advanced NES cell may include a timestamp. The stored UL WUS configuration may be considered valid when the timestamp has not arrived. The stored UL WUS configuration may be considered invalid when the timestamp has arrived.

In some implementations, a UL WUS configuration of an advanced NES cell may include an on-demand SIB1 broadcast status indication. When a UE attempts to camp on the advanced cell and the on-demand SIB1 broadcast status indication is set to “notBroadcasting”, the UE may determine to perform an on-demand SIB1 procedure. When a UE attempts to camp on the advanced cell and the on-demand SIB1 broadcast status indication is set to “Broadcasting”, the UE may not determine to perform an on-demand SIB1 procedure and may start receiving/acquiring an on-demand SIB1 of the advanced NES cell by monitoring the received information of type 0 PDCCH and/or associated search space ZERO. In some implementations, the advanced NES cell may provide an on-demand SIB1 broadcast status indication in its MIB or RAR (in response to a preamble for an on-demand SIB1 request). In one implementation, a UE may receive an on-demand SIB1 broadcast status indication in an RAR. In another implementation, a UE may receive an on-demand SIB1 broadcast status indication in the MIB of the advanced NES cell. In one example, the ssb-SubcarrierOffset field (as introduced in TS 38.331 of Release 18) in MIB may be used to indicate that the on-demand SIB1 is absent (or its broadcast status is “notBroadcasting”). In another example, the pdcch-ConfigSIB1 field (as introduced in TS 38.331 of Release 18) in the MIB may be used to indicate that the on-demand SIB1 is absent (or its broadcast status is “notBroadcasting”).

In some implementations, a UL WUS configuration of an advanced NES cell may include an RSRP (Reference Signal Receiving Power) threshold. The RSRP threshold may be used for a UE to determine whether to camp on an advanced NES cell and/or whether to perform an on-demand SIB1 request procedure to an advanced NES cell. In some implementations, the value of the RSRP threshold may be a common one, i.e., common for all provided UL WUS configurations. In some implementations, each UL WUS configuration may include its specific value for the RSRP threshold. In some implementations, when a specific value for an RSRP threshold is not present (or absent) in a UL WUS configuration and a common value is present, a UE may apply the common value for the RSRP threshold.

In some implementations, when one or more UL WUS configurations provided in broadcasting system information of a cell have been updated, the cell may indicate/notify a system information modification via paging (or paging DCI, short message). An advanced UE (or a Rel-19 NES-capable UE) may apply a SI acquisition procedure from the next modification period. In some implementations, when one or more UL WUS configurations provided in broadcasting system information of a cell have been updated, the cell may indicate/notify a system information modification via paging (or paging DCI, short message). An advanced UE (or a Rel-19 NES-capable UE) may immediately apply a SI acquisition procedure. In some implementations, when one or more UL WUS configurations provided in broadcasting system information of a cell have been updated, the cell may indicate/notify a system information modification via a bit in a short message. For example, the fifth bit of a short message may be used to notify UE(s) that WUS-related system information has been updated. An advanced UE (or a Rel-19 NES-capable UE) may apply a SI acquisition procedure from the next modification period to update the WUS-related system information accordingly. In this way, a UE that is not capable of Rel-19 NES feature(s) does not receive to perform a SI acquisition procedure (and ignore this bit) and can reduce power consumption. In some implementations, when one or more UL WUS configurations provided in broadcasting system information of a cell have been updated, the cell may indicate/notify a system information modification via a bit in a short message. For example, the fifth bit of a short message may be used to notify UE(s) that the WUS-related system information has been updated. An advanced UE (or a Rel-19 NES-capable UE) may apply a SI acquisition procedure immediately to update WUS-related system information accordingly. It is noted that an advanced UE (or a Rel-19 NES-capable UE) may be the UE that is capable of receiving a UL WUS configuration and/or performing an on-demand SIB1 request procedure based on a received UL WUS configuration, but not limited to.

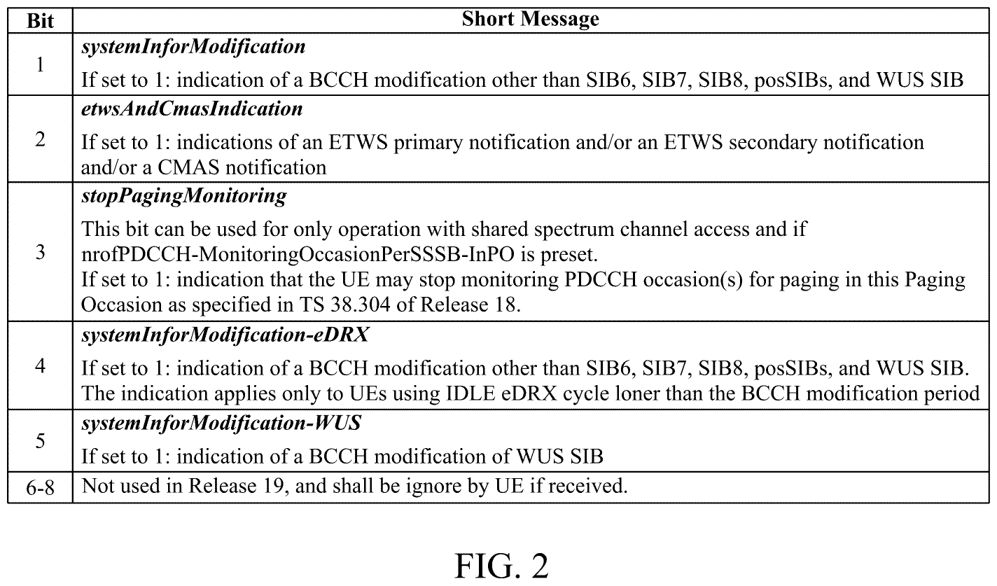

FIG. 2 shows a new design for short messages according to an implementation of the present disclosure. In FIG. 2, when “systemInfoModification” bit is set to 1, the WUS SIB, which includes WUS-related information (or UL WUS configuration(s)), is not considered to be updated. When “systemInfoModification-WUS” bit is set to 1, the WUS SIB, which includes WUS-related information (or UL WUS configuration(s)), is considered to be updated. In case the WUS SIB is indicated to be updated, an advanced UE (or a Rel-19 NES-capable UE) may perform an SI acquisition procedure to receive the updated WUS SIB. It is noted that ETWS stands for Earthquake and Tsunami Warning System, and CMAS stands for Commercial Mobile Alerting System. posSIBs are the positioning SIBs. BCCH means Broadcast Control Channel.

Step 103: In some implementations, a UE may attempt to camp on an advanced NES cell (e.g., the cell B) based on the results of performing a cell re-selection procedure (e.g., as introduced in TS 38.304 of Release 18). The cell B may be the cell with the highest rank based on the cell re-selection criteria and may not be considered to be “barred”. In some implementations, when the cell B is not considered to be “barred”, its signal quality fulfills the configured cell re-selection criteria, and/or its signal quality is better than or equal to an RSRP threshold (if provided), the UE may determine to camp on the cell B.

In some implementations, when an RSRP threshold is provided and the current measured RSRP value (related to an associated advanced NES cell) (e.g., the RSRP of the downlink pathloss reference) is less than or equal to the RSRP threshold, the UE may determine not to camp on the advanced NES cell and may consider the advanced NES cell to be “barred”. The UE may perform a cell re-selection procedure. In another implementation, the UE may remain to camp on the previous cell (e.g., the cell A) when an RSRP threshold is provided and the current measured RSRP value (related to an associated advanced NES cell) (e.g., the RSRP of the downlink pathloss reference) is less than or equal to the RSRP threshold.

In some implementations, a UE (e.g., an advanced UE or a Rel-19 NES-capable UE) that attempts to camp on an advanced NES cell (e.g., the cell B) may consider “intraFreqReselection” in the MIB to be “intraFreqReselectionNES” in the MIB. “intraFreqReselectionNES” in the MIB indicates whether the frequency of the barred NES cell is barred. For example, when the cell B is considered as “barred” and “intraFreqReselectionNES” is set to “not allowed”, other advanced NES cell(s) on the same frequency on which the cell B is deployed is also considered to be “barred”.

In some implementations, when a UE attempts to camp on the cell B or determines to camp on the cell B, the UE may keep (all) the received/stored UL WUS configuration(s) received from the current/previous cell (e.g., the cell A). In some implementations, when a UE attempts to camp on the cell B or determines to camp on the cell B, the UE may release (all) the received/stored UL WUS configuration(s) received from the current/previous cell (e.g., the cell A). In some implementations, once the UE successfully camps on the target advanced NES cell (e.g., the cell B), the UE may release the received/stored UL WUS configuration(s) of other cell(s) but may keep the received/stored UL WUS configuration of the camped cell (e.g., cell B). In some implementations, once the UE successfully camps on the target advanced NES cell (e.g., cell B), the UE may release all the received/stored UL WUS configuration(s). In some implementations, when the UE cannot successfully camp on the target advanced NES cell, the UE may perform a cell re-selection procedure. The UE may re-select another advanced NES cell to camp based on the results of the cell re-selection procedure. In case the UE has the (valid) stored UL WUS configuration of the new target advanced NES cell, the UE may perform an on-demand SIB1 request procedure by transmitting a preamble based on the (valid) stored UL WUS configuration.

In some implementations, when a UE attempts to camp on a cell B or determines to camp on cell B, the UE may start monitoring paging occasion(s) associated with the cell B based on the received/stored paging parameters (e.g., parameters provided in the corresponding UL WUS configuration). In case the UE does not receive/store valid paging parameters of the cell B, the UE may not monitor paging occasion(s) for paging reception on the cell B, before an RA procedure for an on-demand SIB1 request on the cell B is successful, or before the on-demand SIB1 acquisition on the cell B is successful. In case the UE has received/stored valid paging parameters of the cell B, the UE may start monitoring paging occasion(s) for paging reception on the cell B, before an RA procedure for an on-demand SIB1 request on the cell B is successful or before the on-demand SIB1 acquisition on the cell B is successful.

Step 104: In some implementations, when a UE determines to camp on an advanced NES cell (e.g., the cell B), the UE determines whether a certain triggering condition is fulfilled. When a certain triggering condition is fulfilled, the UE may determine to perform an on-demand SIB1 request procedure on the cell B (e.g., transmitting a preamble for an on-demand SIB1 request by initiating an RA procedure). The certain triggering condition(s) may include the on-demand SIB1 is not currently being broadcast (e.g., the on-demand SIB1 broadcast status is set to “notBroadcasting”), the stored on-demand SIB1 version is invalid, the stored UL WUS configuration is valid, and/or the current signal quality measured from the advanced NES cell (e.g., the RSRP of the downlink pathloss reference) is less than or equal to an RSRP threshold.

In some implementations, when a UE determines to camp on an advanced NES cell (e.g., the cell B), but the UE determines that the on-demand SIB1 request procedure is failed or the stored UL WUS configuration is invalid (or unavailable), the UE may consider the cell to be “barred”and/or may perform a cell reselection procedure.

In some implementations, a UE may receive an on-demand SIB1 value tag in the MIB of an advanced NES cell. In one example, the ssb-SubcarrierOffset field (as introduced in TS 38.331 of Release 18) in the MIB may be used to indicate the current value tag. In another example, the pdcch-ConfigSIB1 field (as introduced in TS 38.331 of Release 18) in the MIB may be used to indicate the current value tag. When the UE has a stored on-demand SIB1 of the advanced NES cell with the value tag V1, the UE may compare the value tag V1with the value tag V2 that is indicated in the MIB (by using the ssb-SubcarrierOffset field or the pdcch-ConfigSIB1 field). In case that V1 and V2 are different, the UE may consider that the stored on-demand SIB1 version is invalid and may need to perform an on-demand SIB1 request procedure to the advanced NES cell. In case that V1 and V2 are the same, the UE may consider that the stored on-demand SIB1 version is valid and may not need to perform an on-demand SIN1 request procedure.

In some implementations, when a UE determines to camp on an advanced NES cell (e.g., the cell B) but the current measured RSRP value (related to an associated advanced NES cell) (e.g., the RSRP of the downlink pathloss reference) is less than or equal to the provided RSRP threshold, the UE may consider the cell to be “barred” and/or may perform a cell reselection procedure. In another implementation, the UE may remain to camp on the previous cell (e.g., the cell A) when the current measured RSRP value (related to an associated advanced NES cell) (e.g., the RSRP of the downlink pathloss reference) is less than or equal to the provided RSRP threshold.

In some implementations, a UE (e.g., an advanced UE or a Rel-19 NES-capable UE) that attempts to camp on an advanced NES cell (e.g., the cell B) may consider “intraFreqReselection” in the MIB to be “intraFreqReselectionNES” in the MIB. “intraFreqReselectionNES” in the MIB indicates whether the frequency of the barred NES cell is barred. For example, when the cell B is considered as “barred” and “intraFreqReselectionNES” is set to “not allowed”, other advanced NES cell(s) on the same frequency on which the cell B is deployed are also considered to be “barred”.

In some implementations, before transmitting a preamble for an on-demand SIB1 request, a UE that attempts to camp on the cell B may try/start to receive an on-demand SIB1 of the cell B by monitoring the received information of type 0 PDCCH and/or associated search space ZERO. When the UE determines that the on-demand SIB1 is currently available/broadcast (e.g., due to a request by another UE or the cell B switches to regular mode) and/or the UE successfully receives/acquires the on-demand SIB1, the UE may abort the preamble transmission and/or may terminate the associated RA procedure.

In some implementations, a UE that attempts to camp on the cell B may first determine whether the UE may receive an on-demand SIB1 of the cell B without transmitting a preamble for the on-demand SIB1 request. When the UE determines that it cannot receive any on-demand SIB1 under a certain condition, the UE may transmit a preamble for an on-demand SIB1 request accordingly. For example, before performing an on-demand SIB1 request procedure on the cell B (by transmitting a preamble), a UE that attempts to camp on the cell B may try/start to receive the on-demand SIB1 of the cell B by monitoring the received information of type 0 PDCCH and/or associated search space ZERO within a pre-defined/configured time period TP2. When the UE cannot successfully receive/acquire the on-demand SIB1 within the time period TP2, the UE may perform an on-demand SIB1 request procedure on the cell B by transmitting a preamble accordingly. The time period TP2 may be in unit(s) of slot(s), subframe(s), frame(s), ms(s), second(s), SI window(s), or SI modification period(s). The time period TP2 may be a configured value provided by system information or the corresponding UL WUS configuration.

In some implementations, before receiving an RAR in response to a preamble for an on-demand SIB1 request, a UE that attempts to camp on the cell B may try/start to receive an on-demand SIB1 of the cell B by monitoring the received information of type 0 PDCCH and/or associated search space ZERO. When the UE determines that an on-demand SIB1 is currently available/broadcast (e.g., due to a request by other UE or the cell B switches to regular mode) and/or the UE successfully receives the on-demand SIB1, the UE may stop RAR reception and/or may terminate the associated RA procedure.

Step 105: In some implementations, when a UE determines to perform an on-demand SIB1 request procedure on an advanced NES cell (e.g., the cell B), the UE may initiate an RA procedure by transmitting a preamble based on the corresponding (valid/stored) UL WUS configuration of the advanced NES cell for the on-demand SIB1 request. In some implementations, after transmitting a preamble for the on-demand SIB1 request, the UE may start an RA response window for receiving an RAR in response to the transmitted preamble within the RA response window. When the RAR in response to the transmitted preamble for the on-demand SIB1 request is received within the RA response window, the RAR reception is considered successful, and the initiated RA procedure is considered successfully completed. The lower layer of the UE (e.g., the MAC layer) may indicate the reception of an acknowledgment for the on-demand SIB1 request to the upper layer of the UE (e.g., the RRC layer). In some implementations, the RAR reception is considered successful when the received RAR contains an MAC subPDU with an RAPID (Random Access Preamble identifier) corresponding to or matching the index of the transmitted preamble. In some implementations, when the RAR reception is not considered successful, the UE may perform an RA resource selection procedure for transmitting another preamble for the on-demand SIB1 request. The corresponding power for transmitting another preamble may be increased by the received value of the power ramping step.

In some implementations, the RAR reception is considered successful when the received RAR contains an MAC subPDU with a common RAPID, not the index of the transmitted preamble for the on-demand SIB1 request. The common RAPID is used specifically for the RAR in response to the on-demand SIB1 request. The common RAPID may be predefined or provided in an associated UL WUS configuration of an advanced NES cell.

In some implementations, when the number of transmitting preamble(s) is equal to the received maximum number of preamble transmissions for the on-demand SIB1 request plus one, the lower layer of the UE (e.g., the MAC layer) may indicate an RA problem related to the on-demand SIB1 request to the upper layer of the UE (e.g., the RRC layer), the lower layer may stop transmitting preamble(s) for the on-demand SIB1 request, and/or may stop/terminate the RA procedure initiated by the on-demand SIB1 request. In some implementations, when the upper layer of the UE (e.g., the RRC layer) receives the indication to indicate an RA problem related to the on-demand SIB1 request from the lower layer of the UE (e.g., the MAC layer), the upper layer may consider the target advanced NES cell to be “barred”, may perform a cell re-selection procedure, and/or may indicate the lower layer of the UE to stop/terminate the RA procedure initiated by the on-demand SIB1 request.

In some implementations, when the upper layer of the UE (e.g., the RRC layer) receives the indication to indicate an RA problem related to the on-demand SIB1 request from the lower layer of the UE (e.g., the MAC layer), the upper layer may store the failure information related to the on-demand SIB1 request failure, and may report the failure information in an RRC signal to the network (e.g., when the UE connects to a cell). In some implementation, in a UE Information Response message (which is used by a UE to transfer information requested by the network), there may be an information field (e.g., raInformationCommon) to report the last failed RA procedure, i.e., the failure information related to on-demand SIB1 request failure and/or an associated cell ID (e.g., a cell ID of a target advanced NES cell). In some implementations, in a UE Information Response message (which is used by a UE to transfer information requested by the network), there may be a new RA purpose (e.g., raPurpose) related to an on-demand SIB1 request associated with a cell ID (e.g., a cell ID of a target advanced NES cell).

Step 106: In some implementations, when an advanced NES cell (e.g., the cell B) receives a preamble for an on-demand SIB1 request or the advanced NES cell decides to switch to the regular mode, the advanced NES cell may start broadcasting the on-demand SIB1. In some implementations, the advanced NW cell may start broadcasting the on-demand SIB1 based on the information of on-demand SIB1 related PDCCH (e.g., type 0 PDCCH), on-demand SIB1 related search space (e.g., search space ZERO), on-demand SIB1 periodicity, reference point, starting time, and/or time duration, which is provided to a UE via a corresponding UL WUS configuration, a received RAR in response to a preamble for the on-demand SIB1 request, or the MIB broadcast by itself.

Step 107: In some implementations, when a UE (e.g., an advanced UE or a Rel-19 NES-capable UE) which attempts to camp on an advanced NES cell (e.g., the cell B) has received a RAR in response to a preamble for an on-demand SIB1 request, the UE may start receiving/acquiring the on-demand SIB1 based on the information of on-demand SIB1 related PDCCH (e.g., type 0 PDCCH), on-demand SIB1 related search space (e.g., search space ZERO), on-demand SIB1 periodicity, reference point, starting time, and/or time duration which is received via a corresponding UL WUS configuration, a received RAR in response to a preamble for the on-demand SIB1 request, or the MIB broadcast by the advanced NES cell. In some implementations, when an acknowledgement for the on-demand SIB1 request is received from the lower layer of the UE (e.g., the MAC layer), the upper layer of the UE (e.g., the RRC layer) may start acquiring SIB1 based on the information of on-demand SIB1 related PDCCH (e.g., type 0 PDCCH), on-demand SIB1 related search space (e.g., search space ZERO), on-demand SIB1 periodicity, reference point, starting time, and/or time duration which is received.

In some implementations, when a UE (e.g., an advanced UE or a Rel-19 NES-capable UE) attempts to camp on an advanced NES cell (e.g., the cell B) but cannot successfully receive an on-demand SIB1 (or cannot have a valid on-demand SIB1 version) of a target advanced NES cell, the UE may consider that an on-demand SIB1 acquisition failure has occurred. For example, when the UE cannot receive the on-demand SIB1 within the time duration, the UE may consider that the on-demand SIB1 acquisition failure has occurred or has not been completed. For example, when the UE cannot receive the on-demand SIB1 within a period (which may be configured by the network or decided by the UE itself), the UE may consider that the on-demand SIB1 acquisition failure has occurred or not been completed.

In some implementations, when the UE determines that the on-demand SIB1 acquisition failure has occurred, the UE may consider the target advanced NES cell to be “barred”and/or may perform a cell re-selection procedure.

In some implementations, when a UE (e.g., an advanced UE or a Rel-19 NES-capable UE) that attempts to camp on an advanced NES cell (e.g., the cell B) may consider “intraFreqReselection” in the MIB to be “intraFreqReselectionNES” in the MIB. “intraFreqReselectionNES” in the MIB indicates whether the frequency of the barred NES cell is barred. For example, when the cell B is considered as “barred” and “intraFreqReselectionNES” is set to “not allowed”, other advanced NES cell(s) on the same frequency on which the cell B is deployed are also considered to be “barred”.

In some implementations, when the UE determines that the on-demand SIB1 acquisition failure has occurred, the UE may store the failure information related to the on-demand SIB1 acquisition failure, and may report the failure information in an RRC signal to the network (e.g., when the UE connects to a cell). In some implementations, in a UE Information Response message (which is used by a UE to transfer information requested by the network), there may be an information field to report the last failed on-demand SIB1 acquisition procedure, i.e., the failure information related to on-demand SIB1 acquisition failure and/or an associated cell ID (e.g., a cell ID of a target advanced NES cell).

Step 108: In some implementations, when a UE (e.g., an advanced UE or a Rel-19 NES-capable UE) that attempts to camp on an advanced NES cell (e.g., the cell B) successfully receives the on-demand SIB1, the UE may consider that it successfully camps on the advanced NES cell.

In some implementations, when a UE (e.g., an advanced UE or a Rel-19 NES-capable UE) camps on an advanced NES cell (e.g., cell B) and receives an SI modification notification (via a paging message, a paging DCI, or a short message), the UE may determines whether to perform an on-demand SIB1 request on the advances NES cell by considering certain triggering condition(s). The certain triggering condition(s) may include that the on-demand SIB1 is not currently being broadcast (e.g., the on-demand SIB1 broadcast status is set to “notBroadcasting”), the stored on-demand SIB1 version is invalid, and/or the stored UL WUS configuration is valid. In case the on-demand SIB1 is not currently being broadcast, the stored on-demand SIB1 version is invalid, and/or the stored UL WUS configuration is invalid, the UE may consider the advanced NES cell to be “barred”, and may perform a cell re-selection procedure to select another cell to camp on.

In some implementations, when a UE (e.g., an advanced UE or a Rel-19 NES-capable UE) camps on an advanced NES cell (e.g., the cell B) and receives an SI modification notification (via a paging message, a paging DCI, or a short message), the UE may assume/expect that the advanced NES cell may start broadcasting the on-demand SIB1, and the UE may start monitoring on-demand SIB1 related PDCCH (e.g., type 0 PDCCH) and/or on-demand SIB1 related search space (e.g., search space ZERO) to receive/acquire the on-demand SIB1. That is, the UE does not need to perform an on-demand SIB1 procedure for the SI update/modification upon receiving the SI modification notification. In some implementations, when the UE has a valid on-demand SIB1 version, the UE may not need to receive/acquire the on-demand SIB1.

In some implementations, when a UE (e.g., an advanced UE or a Rel-19 NES-capable UE) camps on an advanced NES cell (e.g., the cell B) and receives a notification of WUS related system information being updated (via a paging message, a paging DCI, or a short message), the UE may assume/expect that the advanced NES cell may start broadcasting the on-demand SIB1 and the updated WUS relation system information (in an existing SIB or a new designed SIB), and the UE may start monitoring an on-demand SIB1 related PDCCH (e.g., type 0 PDCCH) and/or an on-demand SIB1 related search space (e.g., search space ZERO) to receive/acquire the on-demand SIB1. Once receiving the on-demand SIB1, the UE may start receiving/acquiring SIB(s), including WUS relation system information. In some implementations, when the UE has a valid on-demand SIB1 version, the UE may not need to receive/acquire the on-demand SIB1.

In some implementations, when a UE (e.g., an advanced UE or a Rel-19 NES-capable UE) camps on an advanced NES cell (e.g., the cell B), the UE receives a notification of WUS-related system information being updated (via a paging message, a paging DCI, or a short message) and the UE has a valid UL WUS configuration of the advanced NES cell, the UE may always perform an on-demand SIB1 request procedure.

In some implementations, the NW may instruct a UE (e.g., an advanced UE or a Rel-19 NES-capable UE) that camps on an advanced NES cell whether to perform an on-demand SIB1 request procedure for an SI update/modification. For example, an UL WUS configuration may include an indicator that indicates whether an on-demand SIB1 request procedure needs to be performed for the SI update/modification upon receiving an SI modification notification or a notification of WUS-related system information being updated. In another example, an SIB may include an indicator that indicates whether an on-demand SIB1 request procedure needs to be performed for the SI update/modification upon receiving an SI modification notification or a notification of WUS-related system information being updated.

Step 109: In some implementations, a UE (e.g., an advanced UE or a Rel-19 NES-capable UE) may perform an RRC connection establishment or an RRC connection resume procedure (e.g., when the UE has any DL data to receive or UL data to transmit, or when the UE receives a paging message to indicate the UE to connect to the network). In case the UE is in the RRC_IDLE state, the UE may perform an RRC connection establishment to connect to the advanced NES cell (e.g., the cell B). In case the UE is in the RRC_INACTIVE state, the UE may perform an RRC connection resume to connect to the advanced NES cell (e.g., the cell B).

In some implementations, before a UE (e.g., an advanced UE or a Rel-19 NES-capable UE) performs an RRC connection establishment or an RRC connection resume procedure to connect to an advanced NES cell (e.g., the cell B), the UE may need to determine whether the UE has a valid (on-demand) SIB1. When the UE does not have a valid (on-demand) SIB1, the UE may need to perform an on-demand SIB1 request procedure based on a valid UL WUS configuration associated with the advanced NES cell. In case the UE does not have a valid (on-demand) SIB1 and/or does not have a valid UL WUS configuration, the UE may consider the advanced NES cell as “barred”.

In some implementations, a UE (e.g., an advanced UE or a Rel-19 NES-capable UE) in the RRC_CONNECTED state may report its capability of supporting an on-demand SIB1 request, an on-demand SSB request, and/or adaptation on time for common channels/signaling. With the capability reporting, the NW may decide which content/configuration may be included in a control signaling (e.g., an RRC Release message).

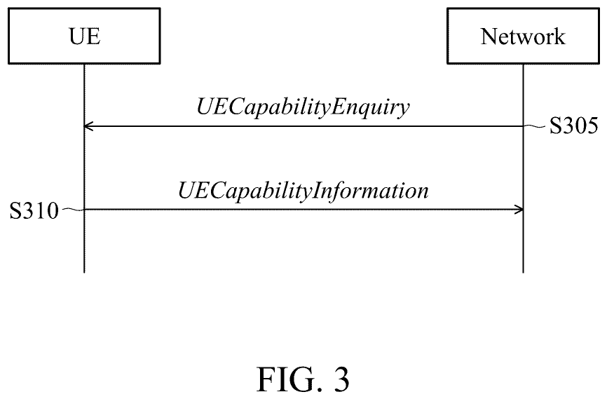

FIG. 3 shows a UE capability reporting procedure according to an implementation of the present disclosure. The network (NW) may initiate this procedure to a UE in the RRC_CONNECTED state when the NW needs UE capability information. That is, the NW may transmit a UE capability enquire message (i.e., UECapabilityEnquiry message) to the UE in step S305, and then the UE may report the requested UE capability message in a UE capability information message (i.e., UECapabilityInformation message) in step S310.

In one implementation, a UE may report its capability of supporting all the Rel-19 NES features, including at least supporting an on-demand SIB1 request, an on-demand SSB request, and adaptation on time for common channels/signaling. In one implementation, a UE may report separate capabilities of supporting different Rel-19 NES features. For example, a UE may report one capability of supporting an on-demand SIB1 request, a capability of supporting an on-demand SSB request, and/or a capability of supporting adaptation on time for common channels/signaling (e.g., for PCH).

In some implementations, the capabilities may be separated for TDD (Time Division Duplex) and FDD (Frequency Division Duplex). For example, a UE may report one capability of supporting an on-demand SIB1 request in TDD and report another capability of supporting an on-demand SIB1 request in FDD. In some implementations, the capabilities may be separated for FR1 (Frequency Range 1) and FR2 (Frequency Range 2). For example, the UE may report a capability of supporting an on-demand SIB1 request in FR1 and report another capability of supporting an on-demand SIB1 request in FR2.

Step 110: In some implementations, a UE (e.g., an advanced UE or a Rel-19 NES-capable UE) in the RRC_CONNECTED state may receive an RRC Release message from a serving cell (e.g., the cell B). In one example, the serving cell (e.g., the cell B) may transmit an RRC Release message without a suspend configuration to transit the UE to the RRC_IDLE state. In another example, the serving cell (e.g., the cell B) may transmit an RRC Release message with a suspend configuration to transit the UE to the RRC_INACTIVE state.

In some implementations, an RRC Release message may include one or more UL WUS configurations associated with one or more advanced NES cells. The UE may store the one or more UL WUS configurations in the RRC_IDLE state. Once the UE transits to the RRC_CONNECTED state, the UE may release the one or more UL WUS configurations. In another implementation, once the UE transits to the RRC_CONNECTED state, the UE may release the stored UL WUS configurations, but may keep the UL WUS configuration associated with the serving cell.

In some implementations, a suspend configuration of an RRC Release message may include one or more UL WUS configurations associated with one or more advanced NES cells. The UE may store the one or more UL WUS configurations in the RRC_IDLE state. Once the UE transits to the RRC_CONNECTED state, the UE may release the one or more UL WUS configurations. In another implementation, once the UE transits to the RRC_CONNECTED state, the UE may release the stored UL WUS configuration(s), but may keep the UL WUS configuration(s) associated with the serving cell.

In some implementations, when a UE (e.g., an advanced UE or a Rel-19 NES-capable UE) has already stored one or more UL WUS configurations via system information, the UE may update/add/delete the stored one or more UL WUS configurations based on the information received via an RRC release message or a suspend configuration of an RRC release message.

In some implementations, when a UE (e.g., an advanced UE or a Rel-19 NES-capable UE) does not receive one or more UL WUS configurations from an RRC Release message or a suspend configuration of an RRC Release message, the UE may try to receive the one or more UL WUS configurations from broadcasting system information, if any.

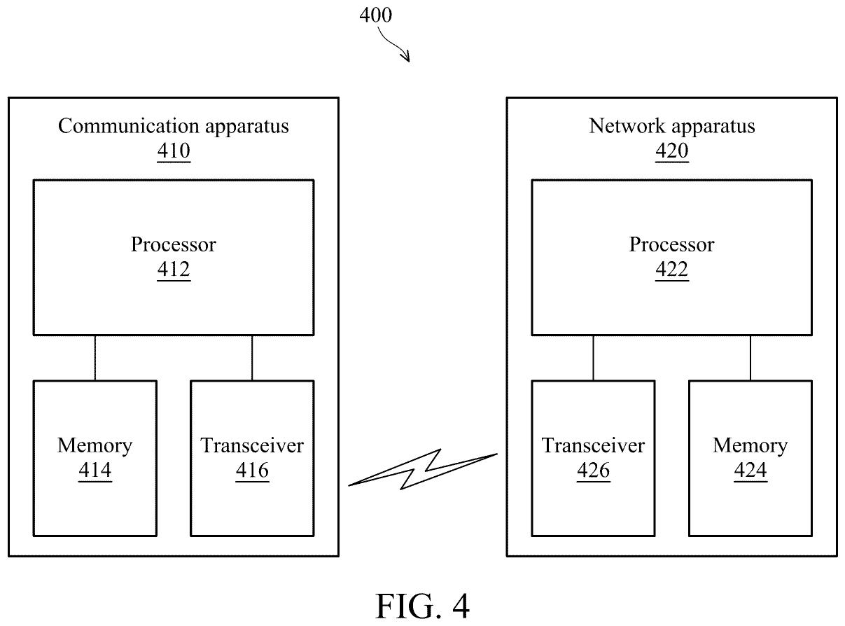

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to performing an on-demand SIB1 request procedure, including scenarios/schemes described above as well as process 400 described below.

The communication apparatus 410 may be a part of an electronic apparatus, which may be a UE such as a portable or mobile apparatus, a wearable apparatus, a wireless communication apparatus or a computing apparatus. For instance, the communication apparatus 410 may be implemented in a smartphone, a smartwatch, a personal digital assistant, a digital camera, or a computing equipment such as a tablet computer, a laptop computer or a notebook computer. The communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 410 may be implemented in a smart thermostat, a smart fridge, a smart door lock, a wireless speaker or a home control center. Alternatively, the communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 410 may include at least some of those components shown in FIG. 4 such as a processor 412, for example. The communication apparatus 410 may further include one or more other components not pertinent to the proposed scheme of the present disclosure (e.g., internal power supply, display device and/or user interface device), and, thus, such component(s) of the communication apparatus 410 are neither shown in FIG. 4 nor described below in the interest of simplicity and brevity.

The network apparatus 420 may be a part of an electronic apparatus, which may be a network node such as a BS, a small cell, a router, or a gateway. For instance, the network apparatus 420 may be implemented in a gNB in a 5G, B5G, 6G, IoT, NB-IoT or IIoT network. Alternatively, the network apparatus 420 may be implemented in the form of one or more IC chips, such as, for example and without limitation, one or more single-core processors, one or more multi-core processors, or one or more RISC or CISC processors. The network apparatus 420 may include at least some of those components shown in FIG. 4, such as a processor 422, for example. The network apparatus 420 may further include one or more other components not pertinent to the proposed scheme of the present disclosure (e.g., internal power supply, display device and/or user interface device), and, thus, such component(s) of the network apparatus 420 are neither shown in FIG. 4 nor described below in the interest of simplicity and brevity.

In one aspect, each of the processor 412 and the processor 422 may be implemented in the form of one or more single-core processors, one or more multi-core processors, or one or more CISC processors. That is, even though a singular term “a processor” is used herein to refer to the processor 412 and the processor 422, each of the processor 412 and the processor 422 may include multiple processors in some implementations and a single processor in other implementations in accordance with the present disclosure. In another aspect, each of the processor 412 and the processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 412 and the processor 422 is a special-purpose machine specifically designed, arranged and configured to perform specific tasks including a method for on-demand SIB1 requests in a UE (e.g., as represented by the communication apparatus 410) and a serving cell (e.g., as represented by the network apparatus 420) in accordance with various implementations of the present disclosure.

In some implementations, the communication apparatus 410 may also include a transceiver 416 coupled to the processor 412 and capable of wirelessly transmitting and receiving control and data signals. In some implementations, the transceiver 416 may be capable of wirelessly communicating with different types of BSs of different RATs. In some implementations, the transceiver 416 may be equipped with a plurality of antenna ports (not shown), such as, for example, four antenna ports. That is, the transceiver 416 may be equipped with multiple transmit antennas and multiple receive antennas for multiple-input multiple-output (MIMO) wireless communications. In some implementations, the network apparatus 420 may also include a transceiver 426 coupled to the processor 422 and capable of wirelessly transmitting and receiving control and data signals. In some implementations, the transceiver 426 may be capable of wirelessly communicating with different types of UEs of different RATs. In some implementations, the transceiver 426 may be equipped with a plurality of antenna ports (not shown), such as, for example, four antenna ports. That is, the transceiver 426 may be equipped with multiple transmit antennas and multiple receive antennas for MIMO wireless communications. Accordingly, the communication apparatus 410 and the network apparatus 420 may wirelessly communicate with each other via the transceiver 416 and the transceiver 426, respectively.

In some implementations, the communication apparatus 410 may further include a memory 414 coupled to the processor 412 and capable of being accessed by the processor 412 and storing data therein. In some implementations, the network apparatus 420 may further include a memory 424 coupled to the processor 422 and capable of being accessed by the processor 422 and storing data therein. Each of the memory 414 and the memory 424 may include a type of random-access memory (RAM) such as dynamic RAM (DRAM), static RAM (SRAM), thyristor RAM (T-RAM), and/or zero-capacitor RAM (Z-RAM). Alternatively, or additionally, each of the memory 414 and the memory 424 may include a type of read-only memory (ROM) such as mask ROM, programmable ROM (PROM), erasable programmable ROM (EPROM), and/or electrically erasable programmable ROM (EEPROM). Alternatively, or additionally, each of the memory 414 and the memory 424 may include a type of non-volatile random-access memory (NVRAM) such as flash memory, solid-state memory, ferroelectric RAM (FeRAM), magnetoresistive RAM (MRAM), and/or phase-change memory.

Each of the communication apparatus 410 and the network apparatus 420 may be a communication entity capable of communicating with each other using various proposed schemes in accordance with the present disclosure. For illustrative purposes and without limitation, a description of operations, functionalities, and capabilities of the communication apparatus 410, implemented in or as a UE (e.g., the UE in FIGS. 1 and 3), and the network apparatus 420, implemented in or as a serving cell (e.g., the cell A in FIG. 1 or the network in FIG. 3), is provided below.

According to certain proposed schemes of the present disclosure, the processor 412 of the communication apparatus 410 may trigger, via an upper layer of the communication apparatus 410, a lower layer of the communication apparatus 410 to initiate a random access (RA) procedure for an on-demand system information block type 1 (SIB1) request to the network apparatus 420. Then, the processor 412 may consider, via the upper layer of the communication apparatus 410, the network apparatus 420 as barred in a case that an RA problem for the on-demand SIB1 request is received from the lower layer of the communication apparatus 410. The processor 412 may acquire, via the upper layer of the communication apparatus 410, an on-demand SIB1 in a case that an acknowledgment for the on-demand SIB1 request is received from the lower layer of the communication apparatus 410.

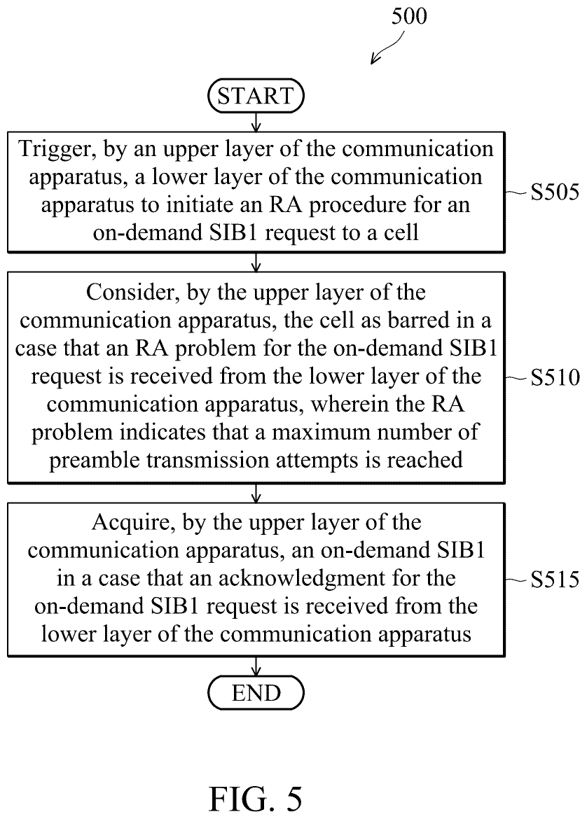

FIG. 5 illustrates an example process 500 in accordance with an implementation of the present disclosure. The process 500 may be an exemplary implementation of above scenarios/schemes, whether partially or completely, with respect to the method for performing an on-demand SIB1 request procedure. The process 500 may represent an aspect of the implementation of features of the communication apparatus 410. The process 500 may include one or more operations, actions, or functions as illustrated by one or more of block S505, S510 and S515. Although illustrated as discrete blocks, various blocks of the process 500 may be divided into additional blocks, combined into fewer blocks, or eliminated, depending on the desired implementation. Moreover, the blocks of the process 500 may be executed in the order shown in FIG. 5 or, alternatively, in a different order. The process 500 may be implemented by the communication apparatus 410 or any suitable UE. Solely for illustrative purposes and without limitation, the process 500 is described below in the context of the communication apparatus 410 as a UE and the network apparatus 420 as a network or a serving cell. The process 500 may begin at block S505.

In S505, the process 500 may involve the processor 412 of the communication apparatus 410 triggering, by an upper layer of the communication apparatus 410, a lower layer of the communication apparatus 410 to initiate a random access (RA) procedure for an on-demand system information block type 1 (SIB1) request to a cell. The process 500 may proceed from S505 to S510.

In S510, the process 500 may involve the processor 412 of the communication apparatus 410 considering, by the upper layer of the communication apparatus 410, the cell as barred in a case that an RA problem for the on-demand SIB1 request is received from the lower layer of the communication apparatus 410, wherein the RA problem indicates that a maximum number of preamble transmission attempts is reached. The process 500 may proceed from S510 to S515.

In S515, the process 500 may involve the processor 412 of the communication apparatus 410 acquiring, by the upper layer of the communication apparatus 410, an on-demand SIB1 in a case that an acknowledgment for the on-demand SIB1 request is received from the lower layer of the communication apparatus 410.

In some implementations, the process 500 may involve the processor 412 of the communication apparatus 410 performing one of: initiating the RA procedure for the on-demand SIB1 request by transmitting a preamble to the cell in a case that the UE has a valid on-demand SIB1 configuration of the cell, and considering the cell as barred in a case that the UE does not have the valid on-demand SIB1 configuration of the cell.

In some implementations, the cell is considered as barred in a case that the communication apparatus 410 does not successfully acquire the on-demand SIB1.

In some implementations, the process 500 may involve the processor 412 of the communication apparatus 410 performing, by the upper layer of the communication apparatus 410, a cell reselection procedure in a case that the RA problem for the on-demand SIB1 request is received from the lower layer of the communication apparatus 410.

In some implementations, the RA procedure for the on-demand SIB1 request is initiated while the communication apparatus 410 is in an IDLE state or in an INACTIVE state.

In some implementations, the on-demand SIB1 is acquired based on information of a starting time and a time duration of type 0 physical downlink control channel (PDCCH) monitoring occasions for the on-demand SIB1 included in a valid on-demand SIB1 configuration of the cell, and the starting time is associated with a reference time point, and the reference time point is determined based on a timing of receiving a corresponding RA response in response to a transmitting preamble for the on-demand SIB1 request.

In some implementations, the process 500 may involve the processor 412 of the communication apparatus 410 transmitting a capability of supporting the on-demand SIB1 request to the communication apparatus 420.

In some implementations, the communication apparatus 410 determines that the RA procedure for the on-demand SIB1 request is initiated on a normal uplink or a supplementary uplink (SUL) based on a reference signal received power (RSRP) threshold in a case that the RSRP threshold is configured.

In some implementations, the process 500 may involve the processor 412 of the communication apparatus 410 transmitting, by the lower layer of the communication apparatus 410, the acknowledgment for the on-demand SIB1 request to the upper layer of the communication apparatus 410 in a case that an RA response of a transmitting preamble for the on-demand SIB1 request is received.

In some implementations, the process 500 may involve the processor 412 of the communication apparatus 410 performing an on-demand SIB1 request procedure in a case that the communication apparatus 410 determines that the on-demand SIB1 is not currently being broadcast.

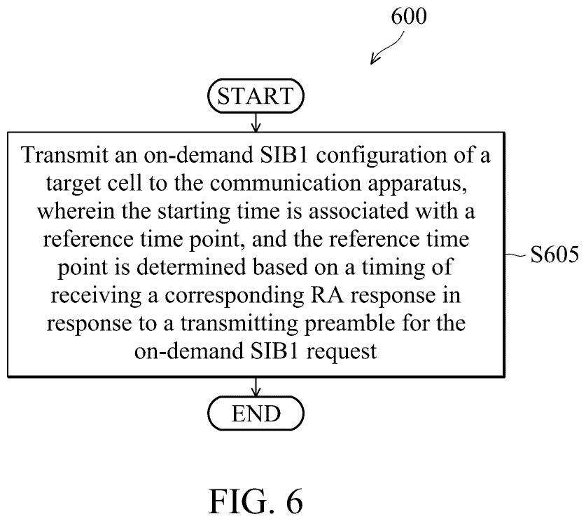

FIG. 6 illustrates an example process 600 in accordance with an implementation of the present disclosure. The process 600 may be an exemplary implementation of the above scenarios/schemes, whether partially or completely, with respect to the method for performing an on-demand SIB1 request procedure. The process 600 may represent an aspect of the implementation of features of the network apparatus 420. The process 600 may include one or more operations, actions, or functions as illustrated by one or more of block S605. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by the network apparatus 620 or any suitable network. Solely for illustrative purposes and without limitation, the process 600 is described below in the context of the communication apparatus 410 as a UE and the network apparatus 420 as a network or a serving cell. The process 600 may begin at block S605.

In S605, the process 600 may involve the processor 422 of the network apparatus 420 transmitting, via the transceiver 426, an on-demand system information block type 1 (SIB1) configuration of a target cell to the communication apparatus 410, wherein the starting time is associated with a reference time point, and the reference time point is determined based on a timing of receiving a corresponding random access (RA) response in response to a transmitting preamble for the on-demand SIB1 request.

In some implementations, the on-demand SIB1 configuration comprises a reference signal received power (RSRP) threshold for the communication apparatus 410 to determine whether an RA procedure for the on-demand SIB1 request is initiated on a normal uplink or a supplementary uplink (SUL).

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for performing an on-demand SIB1 request procedure, wherein the method is implemented by a user equipment (UE), and comprises:
triggering, by an upper layer of the UE, a lower layer of the UE to initiate a random access (RA) procedure for an on-demand system information block type 1 (SIB1) request to a cell;
considering, by the upper layer of the UE, the cell as barred in a case that an RA problem for the on-demand SIB1 request is received from the lower layer of the UE, wherein the RA problem indicates that a maximum number of preamble transmission attempts is reached; and
acquiring, by the upper layer of the UE, an on-demand SIB1 in a case that an acknowledgment for the on-demand SIB1 request is received from the lower layer of the UE.

2. The method as claimed in claim 1, further comprising:
performing one of:
initiating the RA procedure for the on-demand SIB1 request by transmitting a preamble to the cell in a case that the UE has a valid on-demand SIB1 configuration of the cell; and
considering the cell as barred in a case that the UE does not have the valid on-demand SIB1 configuration of the cell.

3. The method as claimed in claim 1, wherein the cell is considered as barred in a case that the UE does not successfully acquire the on-demand SIB1.

4. The method as claimed in claim 1, further comprising:
performing, by the upper layer of the UE, a cell reselection procedure in a case that the RA problem for the on-demand SIB1 request is received from the lower layer of the UE.

5. The method as claimed in claim 1, wherein the RA procedure for the on-demand SIB1 request is initiated while the UE is in an IDLE state or in an INACTIVE state.

6. The method as claimed in claim 1, wherein the on-demand SIB1 is acquired based on information of a starting time and a time duration of type 0 physical downlink control channel (PDCCH) monitoring occasions for the on-demand SIB1 included in a valid on-demand SIB1 configuration of the cell; and
wherein the starting time is associated with a reference time point, and the reference time point is determined based on a timing of receiving a corresponding RA response in response to a transmitting preamble for the on-demand SIB1 request.

7. The method as claimed in claim 1, further comprising:
transmitting a capability of supporting the on-demand SIB1 request to the cell.

8. The method as claimed in claim 1, wherein the UE determines that the RA procedure for the on-demand SIB1 request is initiated on a normal uplink or a supplementary uplink (SUL) based on a reference signal received power (RSRP) threshold in a case that the RSRP threshold is configured.

9. The method as claimed in claim 1, further comprising:
transmitting, by the lower layer of the UE, the acknowledgment for the on-demand SIB1 request to the upper layer of the UE in a case that an RA response of a transmitting preamble for the on-demand SIB1 request is received.

10. The method as claimed in claim 1, further comprising:
performing, by the UE, an on-demand SIB1 request procedure in a case that the UE determines that the on-demand SIB1 is not currently being broadcast.

11. An apparatus for performing an on-demand SIB1 request procedure, comprising:
a transceiver which, during operation, wirelessly communicates with at least one network node; and
a processor communicatively coupled to the transceiver such that, during operation, the processor performs operations comprising:
triggering, by an upper layer of the apparatus, a lower layer of the apparatus to initiate a random access (RA) procedure for an on-demand system information block type 1 (SIB1) request to a cell;
considering, by the upper layer of the apparatus, the cell as barred in a case that an RA problem for the on-demand SIB1 request is received from the lower layer of the apparatus, wherein the RA problem indicates that a maximum number of preamble transmission attempts is reached; and
acquiring, by the upper layer of the apparatus, an on-demand SIB1 in a case that an acknowledgment for the on-demand SIB1 request is received from the lower layer of the apparatus.

12. The apparatus as claimed in claim 11, wherein the processor further performs operations comprising:
performing one of:
initiating the RA procedure for the on-demand SIB1 request by transmitting a preamble to the cell in a case that the apparatus has a valid on-demand SIB1 configuration of the cell; and
considering the cell as barred in a case that the apparatus does not have the valid on-demand SIB1 configuration of the cell.

13. The apparatus as claimed in claim 11, wherein the cell is considered as barred in a case that the apparatus does not successfully acquire the on-demand SIB1.

14. The apparatus as claimed in claim 11, wherein the processor further performs operations comprising:
performing, by the upper layer of the apparatus, a cell reselection procedure in a case that the RA problem for the on-demand SIB1 request is received from the lower layer of the apparatus.

15. The apparatus as claimed in claim 11, wherein the RA procedure for the on-demand SIB1 request is initiated while the apparatus is in an IDLE state or in an INACTIVE state.

16. The apparatus as claimed in claim 11, wherein the on-demand SIB1 is acquired based on information of a starting time and a time duration of type 0 PDCCH monitoring occasions for the on-demand SIB1 included in a valid on-demand SIB1 configuration of the cell; and
wherein the starting time is associated with a reference time point, and the reference time point is determined based on a timing of receiving a corresponding RA response in response to a transmitting preamble for the on-demand SIB1 request.

17. The apparatus as claimed in claim 11, wherein the processor further performs operations comprising:
transmitting a capability of supporting the on-demand SIB1 request to the cell.

18. The apparatus as claimed in claim 11, wherein the UE determines that the RA procedure for the on-demand SIB1 request is initiated on a normal uplink or a supplementary uplink (SUL) based on a reference signal received power (RSRP) threshold in a case that the RSRP threshold is configured.

19. The apparatus as claimed in claim 11, wherein the processor further performs operations comprising:
transmitting, by the lower layer of the apparatus, the acknowledgment for the on-demand SIB1 request to the upper layer of the apparatus in a case that an RA response of a transmitting preamble for the on-demand SIB1 request is received.

20. The apparatus as claimed in claim 11, wherein the processor further performs operations comprising:
performing an on-demand SIB1 request procedure in a case that the apparatus determines that the on-demand SIB1 is not currently being broadcast.

21. A method for performing an on-demand SIB1 request procedure, wherein the method is implemented by a serving cell, and comprises:
transmitting an on-demand system information block type 1 (SIB1) configuration of a target cell to a user equipment (UE), wherein the valid on-demand SIB1 configuration of the target cell at least comprises information of a starting time and a time duration of type 0 physical downlink control channel (PDCCH) monitoring occasions for an on-demand SIB1;
wherein the starting time is associated with a reference time point, and the reference time point is determined based on a timing of receiving a corresponding random access (RA) response in response to a transmitting preamble for the on-demand SIB1 request.

22. The method as claimed in claim 21, wherein the on-demand SIB1 configuration comprises a reference signal received power (RSRP) threshold for the UE to determine whether an RA procedure for the on-demand SIB1 request is initiated on a normal uplink or a supplementary uplink (SUL).
